(19) United States
(12) Patent Application Publication
(10) Pub. No.: US 2022/0316728 A1
(43) Pub. Date: Oct. 6, 2022

(54) SCENTED AIR FILTER SYSTEM FOR HVAC SYSTEMS

(71) Applicant: John Giroux, Green Island, NY (US)

(72) Inventor: John Giroux, Green Island, NY (US)

(21) Appl. No.: 17/698,044

(22) Filed: Mar. 18, 2022

Related U.S. Application Data
(60) Provisional application No. 63/167,944, filed on Mar. 30, 2021.

(51) Int. Cl. F24F 8/50; F24F 8/108; F24F 11/61; F24F 11/39

(52) U.S. Cl. CPC F24F 8/50; F24F 8/108; F24F 11/61; F24F 11/39; F24F 2140/00

(57) ABSTRACT

The present invention relates to an HVAC system scented air filter. The scented air filter is configured to secure to an HVAC vent or along the ductwork connected thereto. The air filter includes a pair of air filters for filtering air and a scented layer removably disposed between the pair of air filters. The scented layer can be infused with fragrance and includes a plurality of evaporating fragrance gel discs for dispensing fragrance through the filter. The air filter provides a reminder system, or useful/active life indicator, to notify an owner to change the filter when the fragrance is diminished. The filter can provide an electronic nose sensor to detect fragrance in blowing air or a timer button can provide a reminder to the user to replace the filter. Alternatively, a QR code can be used for reminding the user to replace the filter.

### CROSS-REFERENCE TO RELATED APPLICATION

The present application claims priority to, and the benefit of, U.S. Provisional Application No. 63/167,944, which was filed on Mar. 30, 2021 and is incorporated herein by reference in its entirety.

### FIELD OF THE INVENTION

The present invention relates generally to scent devices and air filters. More specifically, the present invention relates to a scented filter system for heating, ventilation, and air conditioning (HVAC) systems. The filter system provides filters for filtering air and a scented layer for dispensing fragrance through the filter. The filter system also functions as a reminder, or useful/active life indicator, for a user to replace the filter when fragrance is diminished. A plurality of evaporating fragrance gel discs, including essential oils and other fragrances, provide uniform fragrance through the filter. Accordingly, the present disclosure makes specific reference thereto. Nonetheless, it is to be appreciated that aspects of the present invention are also equally applicable to other like applications, devices, and methods of manufacture.

### BACKGROUND

By way of background, individuals use air fresheners, scented candles, spray cans, and more for masking odors in small and enclosed areas. Individuals also use household staples such as baking soda, distilled white vinegar, coffee grounds, vanilla extract, and lemons to get rid of odors. However, these means for removing odors need to be constantly monitored and/or periodically administered by users. They also only provide a short term and partial solution, and typically are only suitable for small places.

HVAC systems of buildings are also a source of unwanted odors. A musty odor is developed in HVAC systems when relative humidity levels of a building in which the HVAC system is installed is disbalanced. HVAC systems are also a source of burning and other odors. Individuals generally put baking soda in HVAC ducts to remove odors which is not only a very short-term solution but is also difficult to implement. Filters of HVAC systems are configured to provide filtering of air blown by and through the HVAC vent; however, existing filters do not provide any means for providing scent or fragrance to the air. It is desired to have a method or device that can be easily installed in HVAC system and provides fragrance through HVAC vents for a longer period of time.

All existing means of fragrant devices are required to be manually checked and monitored to ensure that the gel, liquid, aerosol and more, providing fragrance is not depleted. This requires periodic inspection by a user which is time consuming and is often forgotten or neglected.

Therefore, there exists a long-felt need in the art for a fragrance providing device that is configured to provide fragrance for long periods of time. There is also a long-felt need in the art for an improved HVAC system filter that provides fragrance through the air blown out and through the filter. Additionally, there is a long-felt need in the art for a HVAC filter that has an integrated scented layer for providing fragrance. Moreover, there is a long-felt need in the art for a device that can provide scent and fragrance to all corners of a home. Further, there is a long-felt need in the art for a fragrant device that eliminates use of candles, scent sprays, and more. Furthermore, there is a long-felt need in the art for a scent device that utilizes a reminder system, or useful/active life indicator, to notify users to replace the scent device. Finally, there is a long-felt need in the art for an improved HVAC filter that provides scent or fragrance through blown air from the HVAC vent.

The subject matter disclosed and claimed herein, in one embodiment thereof, comprises an HVAC scented air filter system. The filter system is configured to work with existing HVAC vents and ducts for providing pleasant and filtered air to the surrounding ambient air while reminding users to replace the filter system when the fragrance is diminished or depleted. The filter system comprising a pair of air filters configured to filter unwanted materials from air; a scent layer including a plurality of evaporating scent gels; the scent layer is positioned in a frame element between said pair of air filters; the evaporating scent gels are configured to uniformly dispense fragrance when air is blown therethrough; each gel includes a volatile constituent and one or more essential oils or fragrant gels for dispensing fragrance; and a reminder system, or useful/active life indicator, to notify a user to replace the filter system.

In this manner, the scented air filter system of the present invention for HVAC systems accomplishes all of the forgoing objectives and provides users with a scented HVAC air filter featuring filter layers and scented gel discs. The filter system comes in a variety of sizes and utilizes a reminder system, or useful/active life indicator, to notify the user when to change the filter. The filter system eliminates use of sprays, cans, and other devices and provides fragrance at all corners of an enclosed space.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an HVAC scented air filter system. The filter system comprising a pair of air filters configured to filter unwanted materials from air; a scent layer including a plurality of evaporating scent gels; the scent layer is positioned between said pair of air filters; the evaporating scent gels are configured to uniformly dispense fragrance when air is blown therethrough; each gel includes a volatile constituent and one or more essential oils for dispensing fragrance; an electronic nose sensor for detecting fragrance in blowing air; a LED configured to illuminate when the electronic nose sensor does not detect fragrance in blown air for notifying a user to replace the filter system.

In yet another embodiment, the evaporating scent gels provide fragrance for up to two months, and the air filters are high efficiency particulate air (HEPA) filters.

In yet another embodiment, the air filters have Minimum Efficiency Rating Value (MERV) rating between 8 and 20, and a frame element is disposed between said filters for removably receiving the scent layer.

In yet another embodiment, a scented air releasing HVAC filter system is disclosed. The filter system comprising a pair of HEPA filters having an enclosed space therebetween; a scented layer featuring a plurality of evaporating gel discs positioned in said enclosed space; said evaporating gel discs are configured to uniformly dispense fragrance when air is blown through the filters; a timer push button and an associated speaker disposed on the filter system wherein the speaker is configured to produce a sound after a predetermined time after the time push button is pushed by a user, the predetermined time is one month indicating a user to replace the scented layer with a new one.

In yet another embodiment, the filter system has a recess for accessing said enclosed space for inserting or removing the scented layer.

In yet another embodiment, a modified HVAC system filter device is disclosed. The filter is designed to provide pleasant and filtered air while notifying a user to change the filter. The filter comprising a three-layer HVAC filter with scent infused layer in between the filter layers. The scent infused layer has a plurality of evaporating gel discs for dispensing scent through the filter. The filter has a QR code configured to be scanned by a digital imaging device for displaying a replacement date of the filter wherein a notification is provided to a user on said replacement date for replacing the filter. In yet another embodiment, the filter has a barcode or any other computer readable code.

In yet a further embodiment, a scented layer configured to be attached to an HVAC filter system is disclosed. The scented layer includes a plurality of evaporating gel discs for uniformly dispensing fragrance through the filter system, each evaporating gel disc contains a volatile constituent for evaporation and one or more essential oils for fragrance wherein the disc provides fragrance for up to one month.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a scented HVAC air filter of the present invention in accordance with the disclosed architecture;

FIG. 2 illustrates an exploded view of the scented air filter system of FIG. 1 in accordance with the disclosed architecture;

FIG. 3 illustrates a perspective view of another embodiment of the scented filter system of the present invention for HVAC systems in accordance with the disclosed architecture;

FIG. 4 illustrates a perspective view of yet another embodiment of the scented HVAC air filter of the present invention in accordance with the disclosed architecture;

FIG. 5 illustrates a cross sectional view of the HVAC scented air filter system of the present invention in accordance with the disclosed architecture; and

FIG. 6 illustrates a perspective view showing the air filter system of the present invention installed in a HVAC vent for distributing pleasant and filtered air in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It can be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments can be combined.

As noted above, there is a long-felt need in the art for a fragrance providing device that is configured to provide fragrance for long periods of time. There is also a long-felt need in the art for an improved HVAC system filter that provides fragrance to the air blown through and out of the filter. Additionally, there is a long-felt need in the art for a HVAC filter that has an integrated scented layer for providing fragrance. Moreover, there is a long-felt need in the art for a device that can provide scent and fragrance to all corners of a home. Further, there is a long-felt need in the art for a fragrant device that eliminates use of candles, scent sprays and more. Furthermore, there is a long-felt need in the art for a scent device that utilizes a reminder system, or useful/active life indicator, to notify users to replace the scent device. Finally, there is a long-felt need in the art for an improved HVAC filter that provides scent or fragrance through blown air from the HVAC vent.

The present invention, in one exemplary embodiment, comprises an HVAC scented air filter system. The filter system has a three-layer structure enclosed in a flexible frame. The filter system features a pair of HEPA filters configured to filter unwanted materials; a scent infused layer including a plurality of evaporating scent gel pads; the scent layer is positioned in an enclosed space between said pair of air filters; the evaporating scent gel pads are configured to uniformly dispense trapped fragrance when air is blown therethrough; each gel includes a volatile constituent and one or more essential oils for dispensing fragrance; an electronic nose sensor, or timer sensor, for detecting fragrance (or lack thereof) in blowing air; a LED configured to illuminate when the electronic nose sensor does not detect fragrance in blown air for notifying a user to replace the filter system.

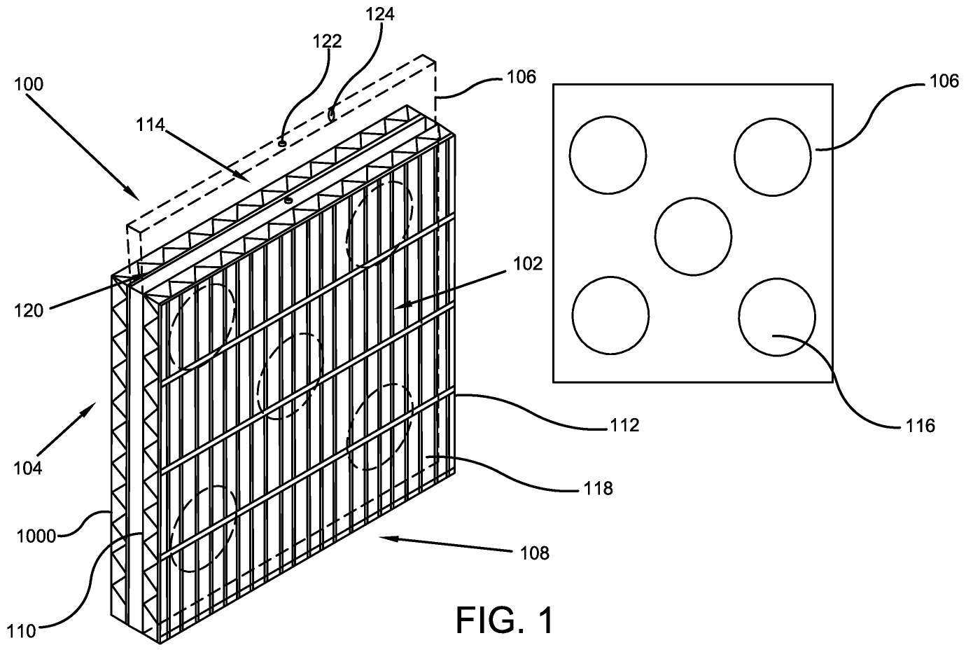

Referring initially to the drawings, FIG. 1 illustrates a perspective view of one potential embodiment of a scented HVAC air filter 100 of the present invention in accordance with the disclosed architecture. The scented HVAC air filter 100 is designed to be used with existing HVAC system vents or anywhere in HVAC duct systems for distributing pleasant air through the HVAC vents. The filter system 100 fulfils the dual purpose of filtering air and providing fragrance thereto. More specifically, the filter system 100 has a plastic frame 1000 that can be generally square or rectangular and is placed in the vent system or in-line to a duct. The frame 1000 provides support to the filter layers and scent layer and is easy to handle while replacing the filter system 100. The frame 1000 includes a bottom end 108, sides 110,112 and a top end 114 and further includes a recess 120 along the top end 114 through which the scent layer 106 is removably placed between the first filter 102 and the second filter 104.

The filters 102,104 are configured to remove air impurities such as pollen, pet dander, dust, and more. The filters 102,104 have fibrous filter material 118 for filtering the impurities. In the preferred embodiment, the filters 102,104 are HEPA filters and are capable of filtering pathogens and smoke as well. The filters 102,104 can have a Minimum Efficiency Rating Value (MERV) rating between 8 and 20. A filter with a MERV rating between 9 and 12 captures particles greater than one micrometer. This includes most dust and common pollutants. Hospital laboratories and residential air conditioners fall within this range.

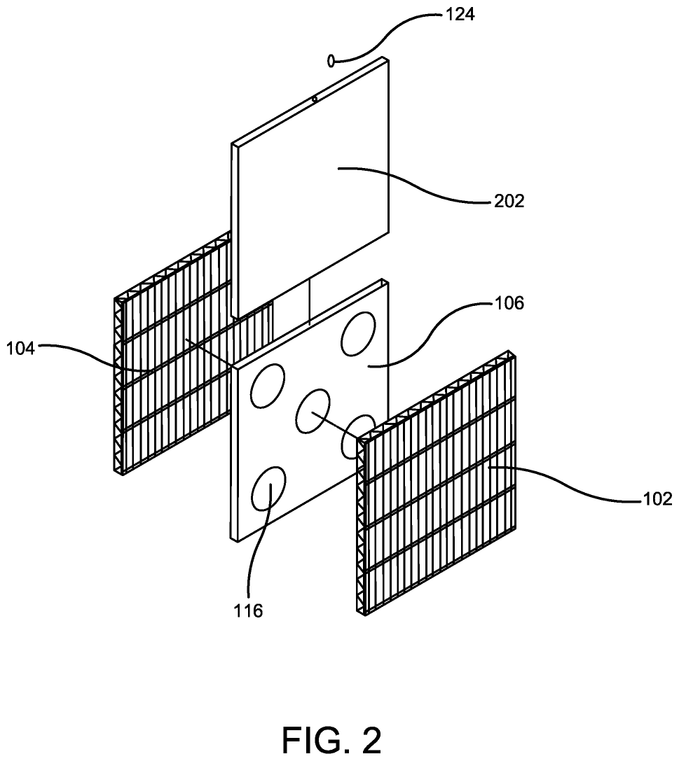

The scent layer 106 is removably placed in a frame element (shown in FIG. 2) between the filters 102,104 for providing fragrance in distributed air through the filter system 100. The scent layer 106 has a plurality of evaporating gel discs 116 for dispensing scent through the filter system 100. The gel discs 116 have essential oils or gels for dispensing fragrance. Additional fragrance can also be trapped in the gel discs 116 during manufacturing of the scent layer 106. The scent layer 106 can have gel discs 116 providing one or more of lime, strawberry, orange, green apple, jasmine, lavender, or more fragrances. The gel discs 116 are configured to evaporate slowly enabling the filter system 100 to provide pleasant, scented, and filtered air for up to two months.

The gel discs 116 have a volatile substance or constituent along with the essential oils to form a clear gel and enabling the gel discs 116 to evaporate over a predetermined period of time to impart a desired fragrance. The term ‘volatile substances’ refers to gases or chemicals that evaporate at room temperature to form a vapor which can be inhaled. Volatiles are defined as substances that quickly evaporate. Examples of volatiles include alcohols. The volatile constituents of the gel discs 116 can evaporate, under typical household conditions over a range of temperature of HVAC ductwork. In the present embodiment, when the fragrance has been depleted, a user is notified by a miniature speaker 124 positioned on the scent layer 124. The speaker 124 is coupled to a timer button 122 which is configured to be pressed by a user upon installation of the filter system 100. The speaker 124 can be programmed to play a sound, or emit an alarm, after a predetermined time duration (i.e., countdown) correlated with depletion of the fragrance of gel discs 116. The user can replace the scent layer 106 with another layer having the same scent previously selected or a differently scented gel to mark the change of seasons, a holiday or other event, or set a different mood. Alternatively, the complete filter system 100 can be replaced by the user. The gel discs 116 are configured to disperse fragrance consistently during the desired period of use (before the predetermined time duration).

FIG. 2 illustrates an exploded view of the scented air filter system 100 of FIG. 1 in accordance with the disclosed architecture. As illustrated, the filter system 100 is a three-layer filter with a first filter layer 102 and a second filter layer 104 filtering out dust and microbes from HVAC air systems. A frame element 202 is positioned between the layers 102,104 and is configured to be removable. The frame element 202 receives the scent layer 106 and enables fragrance from the gels 116 to disperse.

It should be noted that in some embodiments of the filter system 100, the scent layer 106 is directly placed between the filter layers 102,104 without requirement of the frame element. In the present embodiment, the filters 102,104 can last for three months and the scented layer 106 lasts for one month. The speaker 124 is used for reminding requirement of changing scented layer 106 and/or filters 102,104.

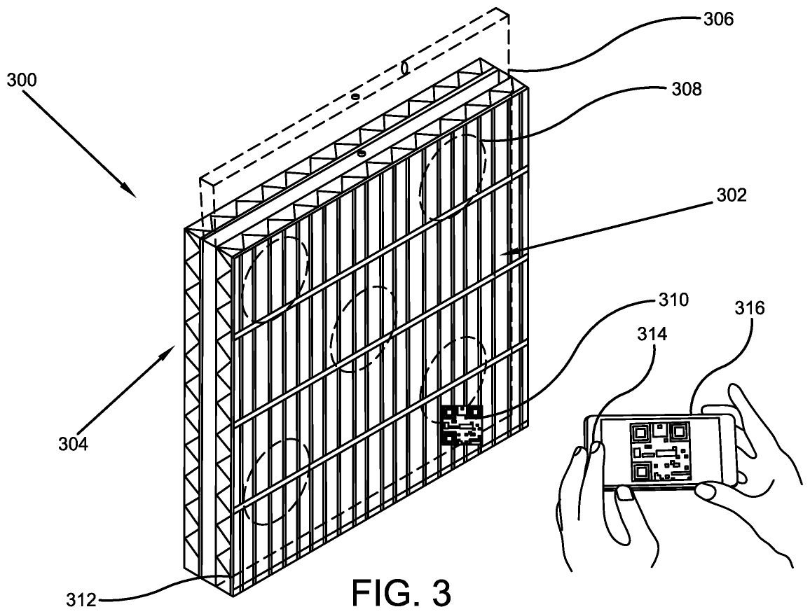

FIG. 3 illustrates a perspective view of another embodiment of the scented filter system of the present invention for HVAC systems in accordance with the disclosed architecture. In the present embodiment, the filter system 300 includes two filter layers 302,304 for filtering air and a scented layer 306 having a plurality of evaporating scented gels 308 for providing fragrance in filtered air. Functionality of the scent layer 306 and the filter layers 302,304 is similar to filter system as described in FIG. 1.

In the present embodiment, the filter system 300 has a QR code or any other computer readable code 310 detectable from a front area. Preferably, the QR code 310 is positioned on front surface 312 of the first filter layer 302, however, the QR code 310 can be positioned at any appropriate place without affecting functionality of the filter system. The QR code 310 is configured to be read by an imaging module (such as digital camera 314 of a smartphone 316) thereby displaying a date on which the filter system 300 was installed and a date on which the filter system 300 is suggested to be replaced. Once the QR code 310 is scanned, the replacement date is stored in a calendar of the smartphone 314 and provides a reminder to notify the user to change the filter system 300.

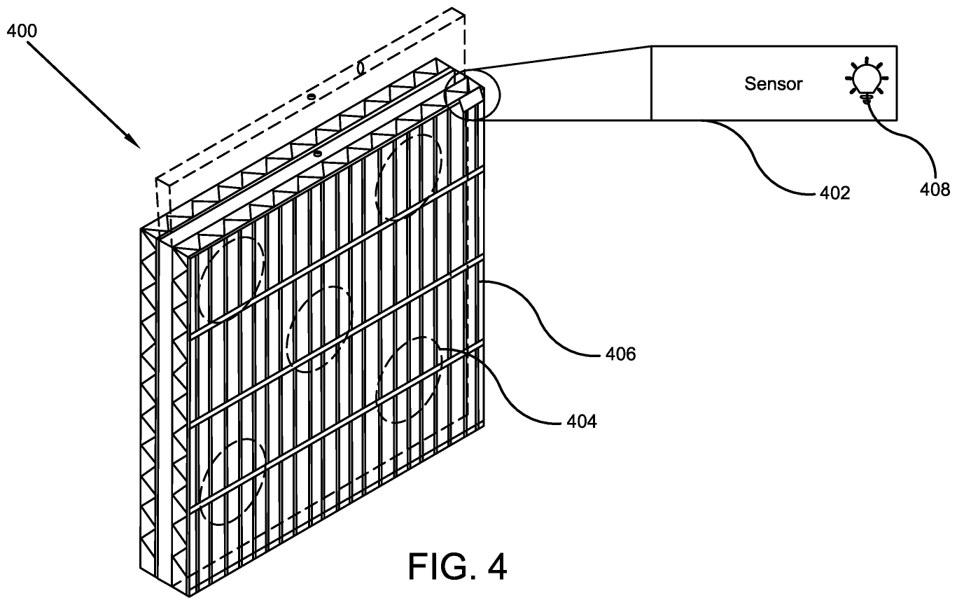

FIG. 4 illustrates a perspective view of yet another embodiment of the scented HVAC air filter of the present invention in accordance with the disclosed architecture. In the present embodiment, the filter system 400 has an electronic nose sensor 402 that is configured to detect fragrance dispensed by the evaporating scent gels 404. The electronic nose sensor 402 is placed on the first filter layer 406 and detects passing air blowing through the scent gels 404.

The sensor 402 is coupled to a low-power LED 408 positioned on the sensor 402 and the sensor 402 illuminates the LED 408 when air without fragrance is detected by the sensor 402. The sensor 402, by illuminating the LED 408, notifies a user to change the filter system 400 as the fragrance is not being dispensed by the scent gels 404. Position of the LED 408 is such that it is readily visible from a naked eye and from a long distance. Further, the LED 408 is provided power for illumination by the sensor 402.

It should be understood that the structure and functionality of various embodiments of the scented filter system of the present invention is same and the mechanism of notifying a user for replacing the filter system and/or scented layer is customized.

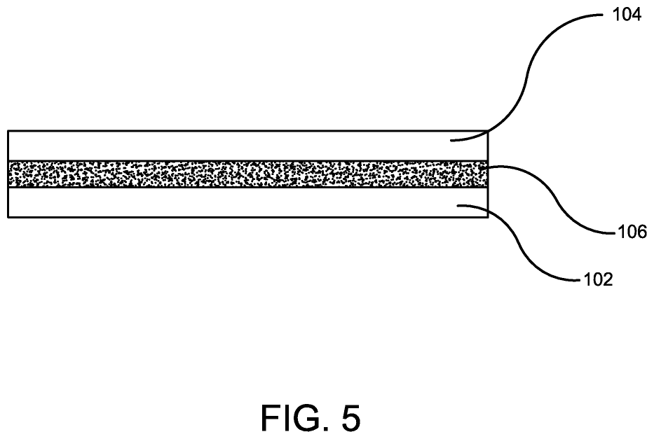

FIG. 5 illustrates a cross sectional view of the HVAC scented air filter system of the present invention in accordance with the disclosed architecture. As illustrated, the two side layers are filter layers 102,104 and are configured to filter air passing through them. The layers 102,104 are substantially of same width and can include similar materials and are configured to filter airborne particles. The filter layers 102,104 are flexible, substantially planar and have uniform thickness. Further, the layers 102,104 have mutually contiguous peripheries when placed or assembled together.

The scent layer 106 is positioned and secured between the two filter layers 102,104 and evaporating gels uniformly dispense fragrance and scent to distribute pleasant air through the HVAC vent. The scent layer 106 has substantially the same thickness as of the filter layers 102,104 and can also be impregnated with a fungicidal, bactericidal, or germicidal material for providing additional protection from pathogens.

The filter system 100,300,400 can have dimensions 10″×20″×1″, 14″×20″×1″, 16″×24″×1″, and 18″×30″×1″. The filter system can also be made in any other sizes of lengths, widths, and thicknesses.

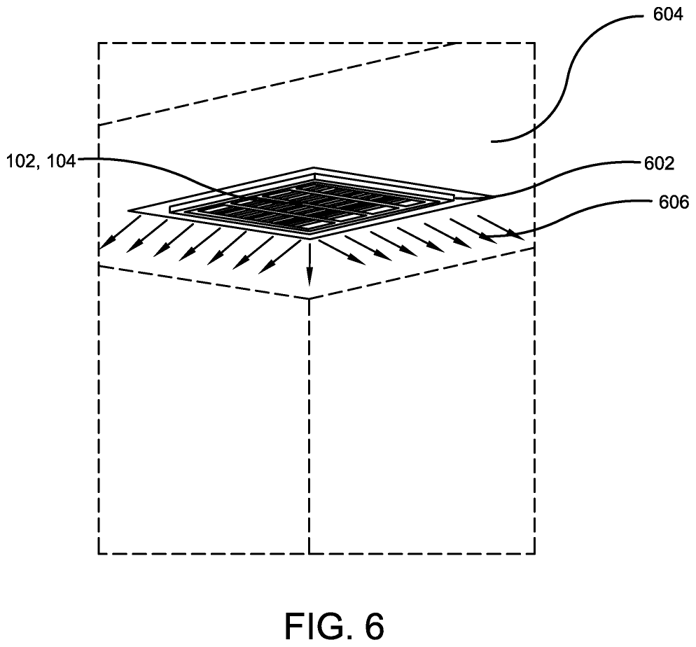

FIG. 6 illustrates a perspective view showing the air filter system of the present invention installed in a HVAC vent for distributing pleasant and filtered air in accordance with the disclosed architecture. As illustrated, the filter system 100 is installed at the vent 602 installed in a ceiling 604. The filter system 100 does not obstruct the air flow 606 while filtering out debris and germs, using the filter layers, and while providing pleasing fragrance, using the scent layer and the evaporating gels.

Certain terms are used throughout the following description and claims to refer to particular features or components. As one skilled in the art will appreciate, different persons can refer to the same feature or component by different names. This document does not intend to distinguish between components or features that differ in name but not structure or function. As used herein “filter system”, “air filter system”, “HVAC scented air filter system”, “HVAC air filter”, and “scented filter system” are interchangeable and refer to the HVAC scented air filter system 100,300,400 of the present invention.

Notwithstanding the forgoing, the HVAC scented air filter system 100,300,400 of the present invention can be of any suitable size and configuration as is known in the art without affecting the overall concept of the invention, provided that it accomplishes the above-stated objectives. One of ordinary skill in the art will appreciate that the HVAC scented air filter system 100,300,400 as shown in the FIGS. are for illustrative purposes only, and that many other sizes and shapes of the HVAC scented air filter system 100,300,400 are well within the scope of the present disclosure. Although the dimensions of the HVAC scented air filter system 100,300,400 are important design parameters for user convenience, the HVAC scented air filter system 100,300,400 can be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art can recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An air filter system for filtering and scenting air passing into HVAC system vents, the air filter system comprising:
a frame secured in an HVAC vent system;
a pair of filter layers; and
a scent layer positioned between the pair of filter layers;
wherein said frame includes a recess along an edge of said frame for accessing said scent layer;
wherein said scent layer is selectively replaceable for providing a scent to a distributed air passing through said air filter system; and
further wherein said scent layer comprises a scent source for dispensing said scent.

2. The air filter system of claim 1, wherein said HVAC vent system comprises an in-line ductwork.

3. The air filter system of claim 1, wherein said filter layers include a MERV rating of between 8 and 20.

4. The air filter system of claim 3, wherein said filter layers include a MERV rating between 9 and 12.

5. The air filter system of claim 4, wherein said filter layers are HEPA filter layers.

6. The air filter system of claim 1, wherein said scent source includes a plurality of gel discs for dispensing said scent.

7. The air filter system of claim 6, wherein said plurality of gel discs comprise an essential oil.

8. The air filter system of claim 7, wherein said plurality of gel discs include a volatile constituent to evaporate over a predetermined period of time.

9. The air filter system of claim 8, wherein said plurality of gel discs further comprise a fragrance selected from a lime, a strawberry, an orange, a green apple, a jasmine and a lavender.

10. An air filter system for filtering and scenting air passing into HVAC system vents, the air filter system comprising:
a frame secured in an HVAC vent system;
a pair of filter layers; and
a scent layer positioned between said pair of filter layers;
wherein said frame includes a recess along an edge of said frame for accessing said scent layer;
wherein said scent layer is selectively replaceable for providing a scent to distributed air passing through said air filter system;
wherein said scent layer includes a scent source for dispensing said scent; and
further wherein said scent layer includes an active life indicator for indicating depletion of said scent source.

11. The air filter system of claim 10, wherein said scent source comprises a plurality of gel discs for dispensing said scent.

12. The air filter system of claim 11, wherein said plurality of gel discs comprise an essential oil.

13. The air filter system of claim 12, wherein said plurality of gel discs comprise a volatile constituent to evaporate over a predetermined period of time.

14. The air filter system of claim 13, wherein said plurality of gel discs further comprise a fragrance selected from a lime, a strawberry, an orange, a green apple, a jasmine and a lavender.

15. An air filter system for filtering and scenting air passing into HVAC system vents, the air filter system comprising:
a frame secured in an HVAC vent system;
a filter layer; and
a scent layer;
wherein said frame comprises a recess along an edge of said frame for accessing said scent layer;
wherein said filter layer and said scent layer are selectively replaceable for providing filtered and scented air passing through said air filter system;
wherein said scent layer includes a scent source for dispensing a scent; and
further wherein said scent layer includes an active life indicator for indicating depletion of said scent source.

16. The air filter system of claim 15, wherein said active life indicator comprises a timer countdown initiated upon installation of said scent layer.

17. The air filter system of claim 16, wherein said active life indicator comprises a speaker for emitting an alarm after a duration of said timer countdown.

18. The air filter system of claim 15, wherein said active life indicator comprises a QR code indicating a date upon which said scent layer was installed.

19. The air filter system of claim 15, wherein said active life indicator comprises an electronic nose sensor for sensing said depletion of said scent source.

20. The air filter system of claim 19, wherein said active life indicator comprises an LED for illumination upon said depletion of said scent source.
